(19) United States
(12) Patent Application Publication
(10) Pub. No.: US 2014/0032858 A1
(43) Pub. Date: Jan. 30, 2014

(54) METHODS AND APPARATUS FOR CACHE LINE SHARING AMONG CACHE CONTROLLERS

(71) Applicants: Vidyalakshmi Rajagopalan, Bangalore (IN); Archna Rai, Bangalore (IN); Anuj Soni, Bangalore (IN); Sharath Kashyap, Bangalore (IN)

(72) Inventors: Vidyalakshmi Rajagopalan, Bangalore (IN); Archna Rai, Bangalore (IN); Anuj Soni, Bangalore (IN); Sharath Kashyap, Bangalore (IN)

(21) Appl. No.: 13/557,967

(22) Filed: Jul. 25, 2012

(51) Int. Cl. G06F 12/08

(52) U.S. Cl. 711/146; 711/141; 711/E12.026

(57) ABSTRACT

Methods and apparatus are provided for cache line sharing among cache controllers. A cache comprises a plurality of cache lines; and a cache controller for sharing at least one of the cache lines with one or more additional caches, wherein a given cache line shared by a plurality of caches corresponds to a given set of physical addresses in a main memory. The cache controller optionally maintains an ownership control signal indicating which portions of the at least one cache line are controlled by the cache and a validity control signal indicating whether each portion of the at least one cache line is valid. Each cache line can be in one of a plurality of cache coherence states, including a modified partial state and a shared partial state.

### CROSS-REFERENCE TO RELATED APPLICATION

The present application is related to U.S. patent application, entitled “Methods and Apparatus for Merging Shared Cache Line Data in a Bus Controller,” (Attorney Docket No. L11-1130US2), filed contemporaneously herewith and incorporated by reference herein.

### BACKGROUND

Computer systems often contain multiple processors and a shared main memory. In addition, several parallel cache memories (typically one cache memory per processor) are often employed to reduce latency when a processor accesses the main memory. Each cache typically has a corresponding cache controller that processes incoming read and write requests based on an order of arrival. The multiple cache controllers with their cache memories typically share a common bus to the main memory. Each cache memory stores data that is accessed from the main memory so that future requests for the same data can be provided to the requesting processor faster. Each entry in a cache has a data value from the main memory and a tag specifying the address in main memory where the data value came from.

When a read or write request is being processed for a given main memory address, the tags in the cache entries are evaluated to determine if a tag is present in a cache that matches the specified main memory address. If a match is found, a cache hit occurs and the data is obtained from the cache instead of the main memory location. If a match is not found, a cache miss occurs and the data must be obtained from the main memory location (and is typically copied into the cache for a subsequent access).

A given data value from the main memory may be stored in more than one cache, and one of the cached copies may be modified by a processor with respect to the value stored in the main memory. Thus, cache coherence protocols are often employed to manage such potential memory conflicts and to maintain consistency between the values stored in the multiple caches and the main memory. For a more detailed discussion of cache coherency, see, for example, Jim Handy, The Cache Memory Book (Academic Press, Inc., 1998).

The Modified, Exclusive, Shared and Invalid (MESI) protocol is a popular cache coherence protocol that refers to the four possible states that a cache line can have under the protocol, namely, Modified, Exclusive, Shared and Invalid states. A Modified state indicates that a copy of a main memory address is present only in the current cache, and the cache line is dirty (i.e., the copy has been modified relative to the value in main memory). An Exclusive state indicates that the copy is the only copy other than the main memory, and the copy is clean (i.e., the copy matches the value in main memory). A Shared state indicates that the copy may also be stored in other caches. An Invalid state indicates that the copy is invalid.

There is a tradeoff between cache latency and hit rate. Larger caches have better hit rates but longer latency. Multi-level caches are often used to address this tradeoff, with smaller fast caches backed up by larger slower caches. Multi-level caches generally operate by checking the smallest cache first, typically referred to as a level 1 (L1) cache. If there is a hit in the L1 cache, the processor proceeds at high speed. If there is a miss in the smaller L1 cache, the next larger cache, typically referred to as an L2 cache, is checked, and so on, before the main memory is accessed.

Frequent accesses to the same cache line by multiple processors to modify the cache line result in frequent eviction (and invalidation) from one cache and allocation in another cache. Typically, the width of the cache line increases with the level of cache hierarchy. Only a portion of a given cache line, however, is typically modified by each write operation. Thus, the ratio of the number of bytes modified by a write operation to the total number of bytes in the cache line reduces significantly with the increase in the level of cache (such as L1, L2, and L3). Hence, the performance penalty due to frequent eviction of larger cache lines at higher levels of the cache hierarchy can be significant.

A need therefore exists for improved cache coherence techniques that reduce the number of evictions of cache lines as well as the subsequent cache line fills.

### SUMMARY

Generally, methods and apparatus are provided for cache line sharing among cache controllers. According to one embodiment of the invention, a cache comprises a plurality of cache lines; and a cache controller for sharing ownership of at least a portion of at least one cache line with one or more additional cache controllers, wherein a given shared cache line corresponds to a given set of physical addresses in a main memory.

In one embodiment, the cache controller maintains an ownership control signal indicating which portions of the shared cache line are controlled and/or modified by the cache controller. For example, the ownership control signal can comprise a bit corresponding to each byte of the shared cache line. The cache controller can also maintain a validity control signal indicating whether each portion of the shared cache line is valid. For example, the validity control signal can comprise a bit corresponding to each byte of the shared cache line.

According to another embodiment of the invention, each of the cache lines can be in one of a plurality of cache coherence states that allow ownership of the cache line to be shared. The plurality of cache coherence states comprises, for example, a modified partial state and a shared partial state that allow cache lines to be shared.

A more complete understanding of embodiments of the invention will be obtained by reference to the following detailed description and drawings.

### BRIEF DESCRIPTION OF THE DRAWINGS

FIG. 1 illustrates a shared memory system in which embodiments of the invention may be employed;

FIG. 2 is a state diagram illustrating the various states and transitions under the conventional four-state MESI protocol;

FIG. 3 is a state diagram illustrating the various states and transitions under an enhanced MESI protocol in accordance with embodiments of the invention;

FIG. 4 illustrates a cache having shared cache lines in accordance with embodiments of the present invention;

FIGS. 5 through 10 illustrate a shared memory system undergoing a number of exemplary transitions in accordance with various embodiments of the present invention;

FIG. 11 is a flow chart describing a cache transaction handling process that may be implemented by a cache controller in accordance with embodiments of the present invention;

FIG. 12 is a flow chart describing a bus transaction handling process that may be implemented by a cache controller to handle snoop requests in accordance with embodiments of the present invention;

FIG. 13 is a flow chart describing a bus transaction handling process that may be implemented by a bus controller in accordance with embodiments of the present invention; and

FIG. 14 is a block diagram of a multiplexer that may be employed by the bus controller to merge the collected shared cache data from the various caches.

### DETAILED DESCRIPTION

Embodiments of the present invention provides partial ownership of cache lines by allowing multiple processors (and their corresponding cache controllers and caches) to share ownership of a given cache line. In particular, different portions of a given cache line can be allocated to different processors. In this manner, the hit rate for cache transactions is improved by reducing the number of evictions of cache lines and reducing subsequent cache line fills. The disclosed cache line sharing techniques offer particular advantages when the processor write operations are narrow relative to the width of each cache line.

According to one embodiment of the invention, the cache access latency is improved by enhancing the cache controller protocol to support additional states. In particular, as discussed further below in a section entitled “Additional States for MESI Protocol,” the conventional four-state MESI protocol is extended to provide two additional states, referred to as a modified partial state and a shared partial state. Under the conventional MESI protocol, only one cache can have ownership of a given modified cache line (i.e., a cache line in a modified state). Embodiments of the invention allow at least a portion of a given cache line to be modified by a plurality of caches, for example, on a per-byte basis.

One embodiment of the invention provides a new modified partial (MP) state so that multiple caches can share the same cache line in a modified state. A control signal OWN_BYTE_LANE_CACHE_LINE (OBL) is provided to indicate the ownership or control of each portion of the cache line (i.e., to specify which cache currently has mutually exclusive control of each portion of the cache line). For example, the OBL control signal can include a bit corresponding to each byte of the cache line, with each bit being set only in the cache that currently has control of the corresponding byte in the shared cache line. The collection of bits specifying ownership or control of each byte of the cache line is also referred to as a “byte strobe.” In addition, a control signal VALID_BYTE_LANE_CACHE_LINE (VBL) is also provided for each cache to indicate the validity of each portion of the cache line in the corresponding cache (i.e., whether each corresponding portion of the cache line in the current cache reflects the latest coherent data).

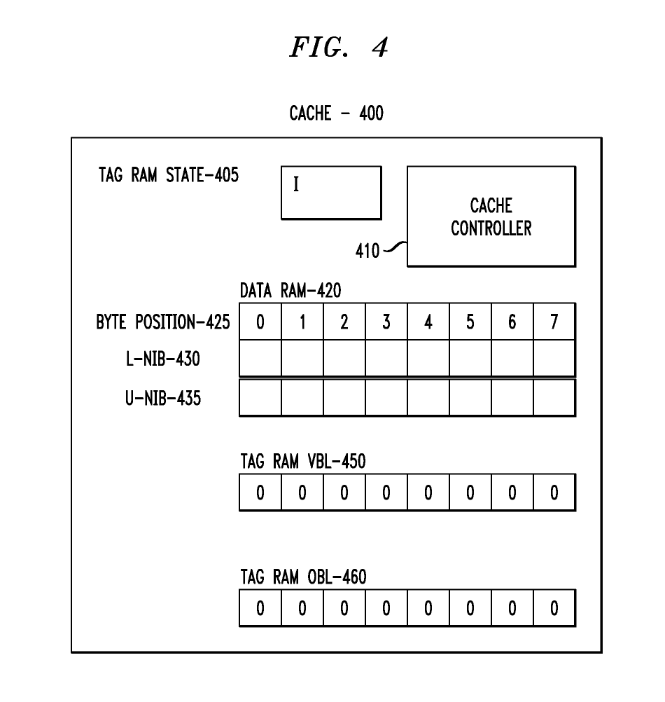

The OBL and VBL values for an exemplary cache 400 having shared cache lines are discussed further below in conjunction with FIG. 4.

Thus, unlike the conventional MESE protocol, where a complete cache line is evicted (and invalidated) for a snoop request, the disclosed cache line sharing approach retains the data that is still modified by the current cache and invalidates only the portion of the cache line that will be written (i.e. modified) by another cache.

Another embodiment of the invention provides a new shared partial (SP) state that allows a cache to selectively retain byte lanes of a cache line with other peer caches modifying the other byte lanes. The VBL signal is used to indicate which byte strobes of the cache line contain the latest coherent data. Thus, as discussed further below, subsequent reads that overlap with the VBL signal in an ‘SP’ state result in a cache hit. In addition, subsequent write operations that overlap with the VBL signal need to inform the peer caches to invalidate the byte lanes that are about to be written and then move from an ‘SP’ state to an ‘MP’ state.

According to a further embodiment of the invention, a bus controller processes the partial ownership information and merges the data from different caches that are in the ‘MP’ state. The bus controller broadcasts the merged data to all of the peer caches so that the caches that have partial ownership of the cache line (i.e., in an MP or SP state for the indicated cache line) can update their VBL control signal and refresh the data with the latest coherent data in the system.

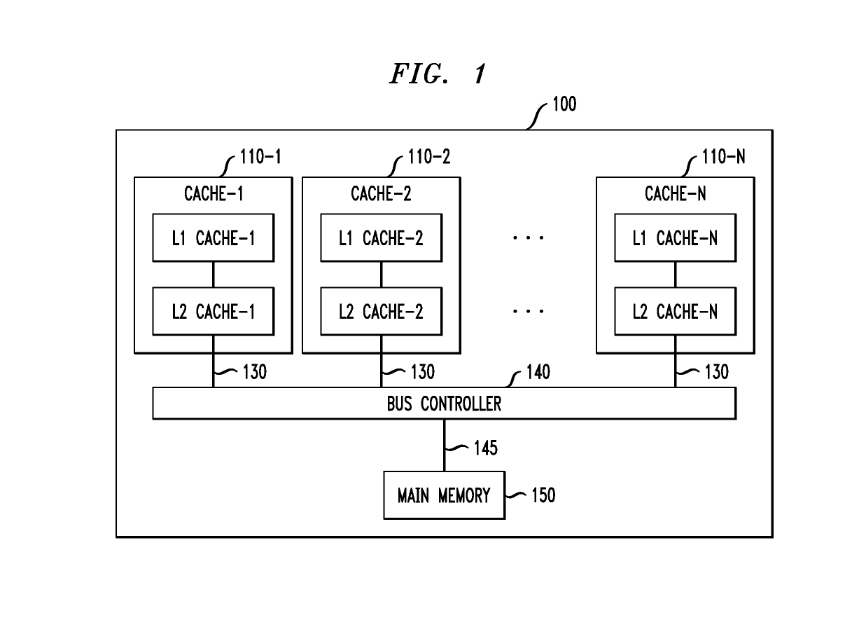

FIG. 1 illustrates a shared memory system 100 in which embodiments of the present invention may be employed. As shown in FIG. 1, the memory system 100 comprises a plurality of caches 110-1 through 110-N (collectively referred to herein as “caches 110”). In the embodiment of FIG. 1, one or more caches 110 is a multi-level cache comprised of, e.g., an L1 cache and an L2 cache. The caches 110 are connected by a bus 130 that is controlled by a bus controller 140. Each cache 110 has a corresponding cache controller (not shown in FIG. 1) that typically processes incoming read and write requests based on an order of arrival. Generally, bus 130 refers to the set of signals between the cache controllers (not shown in FIG. 1) and the bus controller 140 (e.g., snoop request signals, snoop response signals and data phase signals).

A shared main memory 150 is connected to the bus controller 140 by means of a bus 145. The bus 145 is used to perform a write/read operation to or from (respectively) the memory 150 in the case of a snoop response in an invalid (‘I’) state. A cache 110 may store one or more blocks of data, each of which is a copy of data stored in the main memory 150 or a modified version of data stored in main memory 150. Bus snooping is a technique used in a shared memory system, such as the shared memory system 100 of FIG. 1, to achieve coherency among the various caches 110-1 through 110-N. Generally, bus snooping requires each cache controller to monitor the bus 130 to detect an access to a memory address that might cause a cache coherency problem. Snoop requests are messages passed among the caches 110 to determine if any of the caches 110 has a copy of a desired address in the main memory 150. The snoop requests may be transmitted by the bus controller 140 to all of the caches 110 in response to read or write requests. The cache controllers associated with the caches 110 monitor the bus 130, listening for snoop requests that may cause a cache controller to invalidate its cache line. Each cache 110 responds to the snoop request with snoop responses.

A snoop request in accordance with an embodiment of the invention comprises a type of the bus transaction (e.g., a bus write partial, bus read, partial invalidate or an invalidate), a cache line address for which the bus transaction is performed and the byte strobes (BS) of the transaction in the case of a bus write partial operation or a partial invalidate operation. In response to the snoop request, the caches provide the cache state of the given cache line address, if the cache line is present in the current cache along with the OBL (if the bus transaction is a bus write-partial operation). As discussed further below in conjunction with FIG. 4, the OBL values in each cache are mutually exclusive (e.g., a given byte position of a shared cache line can have OBL=1 in only one of the caches at a given time).

In the case of a bus write partial operation or a partial invalidate operation, the byte strobe (BS) included in the snoop request is used by the peer caches to update their VBL and OBL control signals, as discussed further below.

The bus controller 140 receives the snoop responses from each of the caches. If the bus transaction is a bus read or a bus write operation, the data is sourced by all the caches that have ownership of any of the bytes of the cache line. The bus controller uses the OBL control signals previously received during the snoop response to merge the data sent by each of the peer caches to perform the data phase. For a more detailed discussion of the various phases of a cache access, see, for example, U.S. patent application Ser. No. 13/401,022, filed Feb. 21, 2012, entitled “Methods and Apparatus for Reusing Snoop Responses and Data Phase Results in a Bus Controller,” incorporated by reference herein. The merged data provided by the bus controller during the data phase is used by the requesting cache that initiates the bus transaction, as well as by the peer caches if the bus transaction is a bus read operation.

Additional States for MESI Protocol

As previously indicated, the MESI protocol is a popular cache coherence protocol that refers to the four possible states that a cache line can have under the protocol, namely, Modified, Exclusive, Shared and Invalid states.

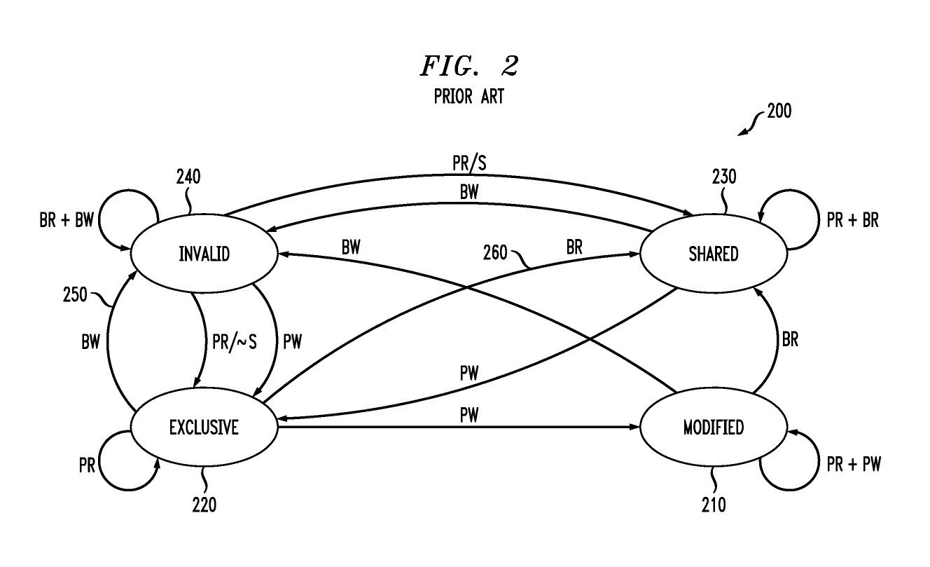

FIG. 2 is a state diagram 200 illustrating the various states and transitions under the conventional four-state MESI protocol. As shown in FIG. 2, a Modified (M) state 210 indicates that a copy of a main memory address is present only in the current cache, and the cache line is dirty (i.e., the copy has been modified relative to the value in main memory). An Exclusive (E) state 220 indicates that the copy is the only copy other than the main memory version, and the copy is clean (i.e., the copy matches the value in main memory). A Shared (S) state 230 indicates that the copy may also be stored in other caches. An Invalid (I) state 240 indicates that the copy is invalid.

FIG. 2 also illustrates the various possible transitions between states for a given operation or combination of operations. As used herein, PR comprises a processor read operation. PW comprises a processor write operation. BR comprises a bus read operation, BW comprises a bus write operation (irrespective of whether it is intended for a partial or full Processor Write), and S/−S comprises shared and not shared states, respectively. For example, transition 250 indicates that a cache line goes from an exclusive state 220 to an invalid state 240 upon a bus write operation on the cache line. Likewise, transition 260 indicates that a cache line goes from an exclusive state 220 to a shared state 230 upon a bus read operation on the cache line.

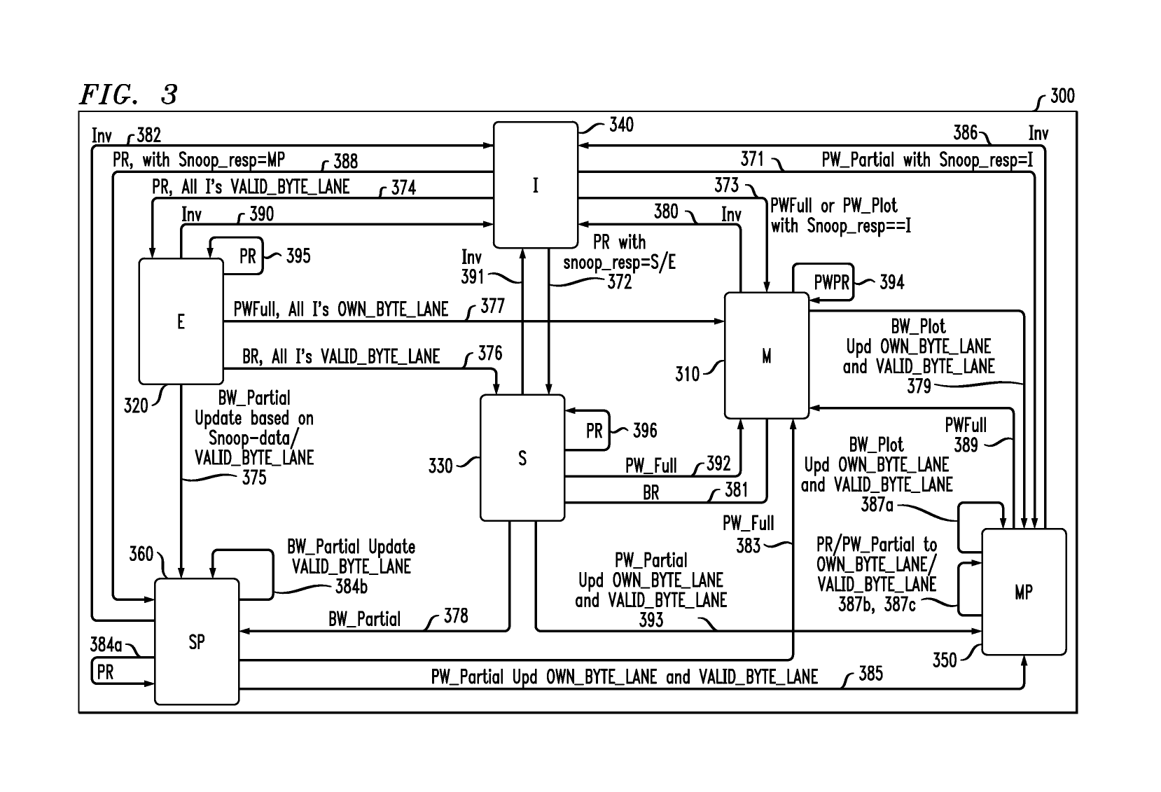

FIG. 3 is a state diagram 300 illustrating the various states and transitions under an enhanced MESI protocol in accordance with an embodiment of the present invention. As shown in FIG. 3, the enhanced MESI protocol comprises the same four states as the conventional MESI protocol of FIG. 2 (namely, a modified state 310, exclusive state 320, shared state 330 and invalid state 340), as well as a new modified partial (MP) state 350 and a new shared partial (SP) state 360.

As previously indicated, the MP state 350 and the SP state 360 allow multiple caches to modify and share the same cache line at a finer resolution. In addition, the SP state 360 allows a cache to retain selective byte lanes of a given cache line with other peer caches modifying the other byte lanes of the given cache line. The Appendix includes a table specifying the exemplary state transitions 371-396 and their respective description.

FIG. 4 illustrates a cache 400 having shared cache lines in accordance with embodiments of the invention. As shown in FIG. 4, the cache 400 comprises a cache controller 410 and a number of cache lines in a multi-byte data RAM 420. One multi-byte cache line is shown in FIG. 4. For each multi-byte cache line, a tag 405 identifies the state of the cache line (e.g., using the states shown in FIG. 3), and the data for each cache line is stored in a Lower Nibble (L-Nib) 430 and an Upper Nibble (U-Nib) 435 of a corresponding Byte Position 425. Each nibble typically stores four bits. The tag RAM also includes the VBL 450 and OBL 460 for each cache line. In one embodiment, a bit within the VBL for a given cache line is set to a binary value of one to indicate a valid state for the corresponding byte and a binary value of zero to indicate an invalid state for the corresponding byte. Likewise, in one embodiment, a bit within the mutually exclusive OBL for a given cache line of a given cache is set to a binary value of one to indicate that the corresponding byte is modified by the current cache and is set to a binary value of zero to indicate that the corresponding byte is not modified by the current cache.

Initially, all of cache lines for the peer caches 110 are in an invalid (I) state 405 and the VBL 450 and OBL 460 are both set to all zeroes.

Exemplary Transitions under Enhanced MESI Protocol

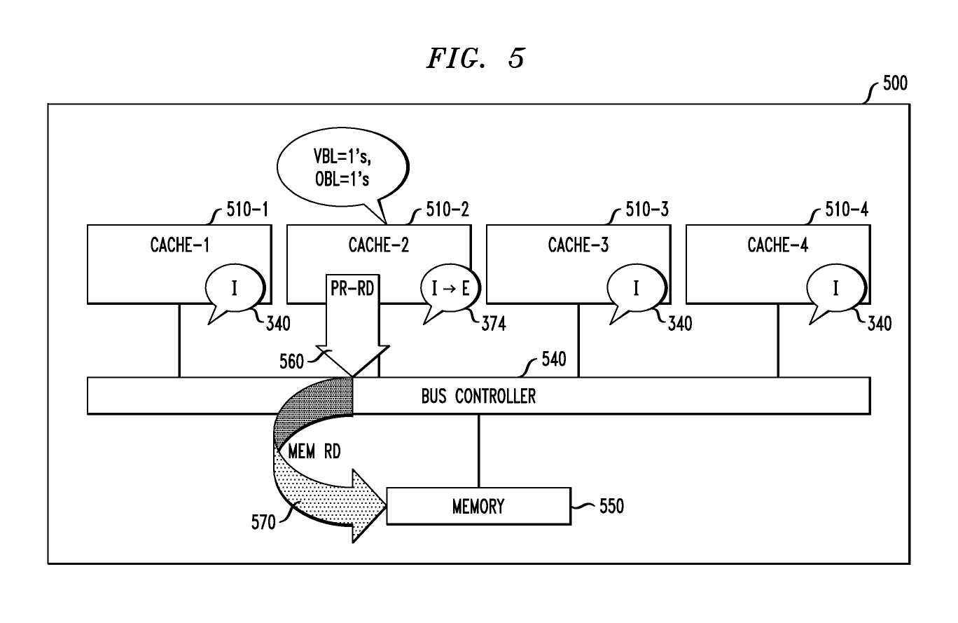

FIG. 5 illustrates a shared memory system 500 following a transition 374 in FIG. 3. In particular, transition 374 occurs for cache 510-2 after a processor associated with cache 510-2 obtains a cache miss following a processor read operation 560. The bus controller 540 then performs a memory read operation 570 to obtain the desired value from main memory 550. The obtained value is then loaded into a cache line in the cache 510-2. The peer caches 510-1, 510-3 and 510-4 all remain in the initial invalid state 340 and their VBL and OBL signals remain at all zeroes. The cache 510-2 transitions from the invalid state 340 to an exclusive state 320, and the VBL and OBL for the cache line are both set to all ones. The transition shown for cache 510-2 in FIG. 5 from the invalid state 340 to an exclusive state 320 corresponds to transition 374 in FIG. 3, as discussed further below in the Appendix.

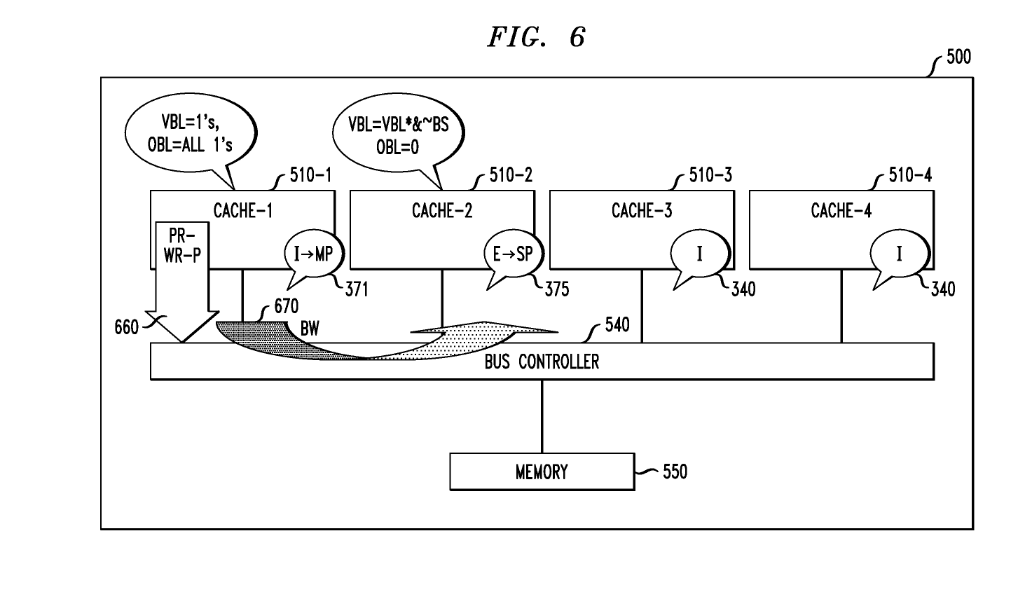

FIG. 6 illustrates the shared memory system 500 following transitions 371 and 375 in FIG. 3. In particular, transitions 371 and 375 occur for cache 510-1 and cache 510-2, respectively, after a processor associated with cache 510-1 performs a processor write-partial operation 660 for a portion of the data value that was previously stored in cache 510-2 following the processor read operation of FIG. 5. For example, the processor associated with cache 510-1 might want to modify a single byte in the cache line. Generally, when there is not already partial ownership of a cache line (determined, for example, by evaluating the snoop responses), the first cache to modify a portion of a cache line gets full ownership of the cache line.

Thus, a bus partial write operation is issued with the byte strobes (BS) indicating the modified portion of the affected cache line. The bus controller 540 then performs a bus write operation 670 to obtain the desired value from cache 510-2. The modified portion of the cache line in cache 510-2 is cleared by setting the validity bit for the modified portion to 0 in the corresponding VBL (the updated VBL is equal to the earlier VBL value logically ANDed with the inverted version of the Byte Strobes for the incoming Bus Write operation 670). The VBL of the cache 510-1 that issued the processor write-partial operation 660 is set to all ones to indicate that the entire cache line is valid. In addition, since the first cache (510-1) to modify a portion of a cache line gets full ownership of the cache line, the OBL is set to all zeroes for cache 510-2 and to all ones for cache 510-1. Finally, the state of cache 510-1 is changed from an invalid state 340 to a modified partial state 350, to reflect the partial ownership. The state of cache 510-2 is changed from an exclusive state 320 to a shared partial state 360, to reflect the partial ownership. The unaffected caches 510-3 and 510-4 remain in the initial invalid state 340 and their VBL and OBL signals remain at all zeroes. The transition shown for cache 510-1 in FIG. 6 from the invalid state 340 to a modified partial state 350 corresponds to transition 371 in FIG. 3, as discussed further below in the Appendix. The transition shown for cache 510-2 in FIG. 6 from the exclusive state 320 to a shared partial state 360 corresponds to transition 375 in FIG. 3, as discussed further below in the Appendix.

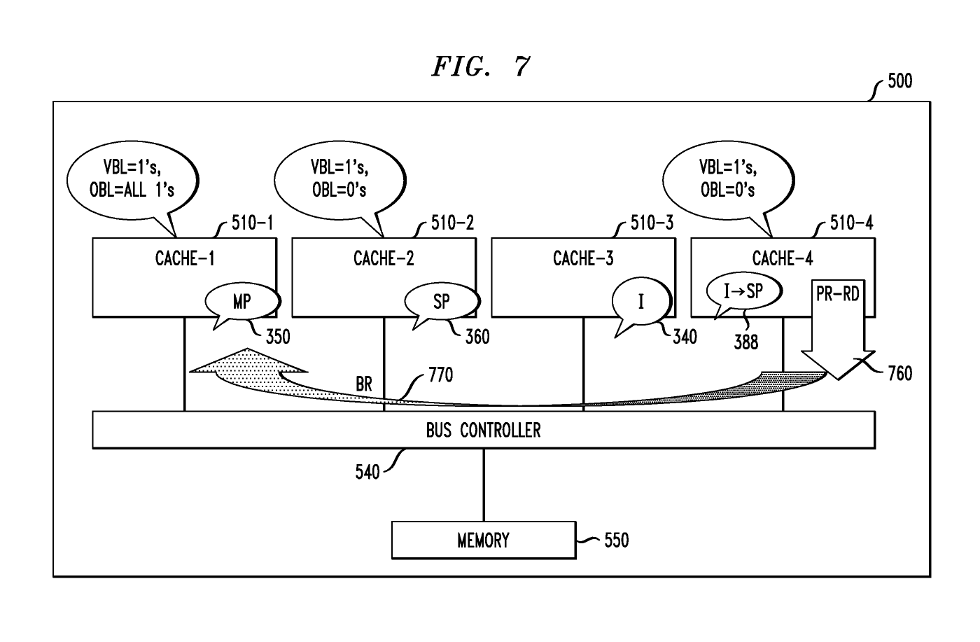

FIG. 7 illustrates the shared memory system 500 following a transition 388 by the cache 510-4 from an Invalid (I) state 340 to a shared partial (SP) state 360 in FIG. 3, prompted by a processor read (PR-RD) operation 760. In particular, transition 388 occurs for cache 510-4 after a processor associated with cache 510-4 performs a processor read operation 760 for the data value that was previously stored in cache 510-1 (in MP state 350) following the operations of FIG. 6.

The bus controller 540 then performs a bus read operation 770 to obtain the desired value from cache 510-1. The cache 510-1 remains in an MP state 350 and maintains all ones for its VBL and OBL, to retain ownership of the cache line. The cache 510-2 remains in an SP state 360, and has its cached data value replenished, so its VBL is set to all ones and its OBL contains all zeroes.

The cache 510-4 associated with the processor that performed the processor read operation 760 has its VBL set to all ones and its OBL set to all zeroes. The transition shown for cache 510-4 in FIG. 7 from the invalid state 340 to a shared partial state 360 corresponds to transition 388 in FIG. 3, as discussed further below in the Appendix.

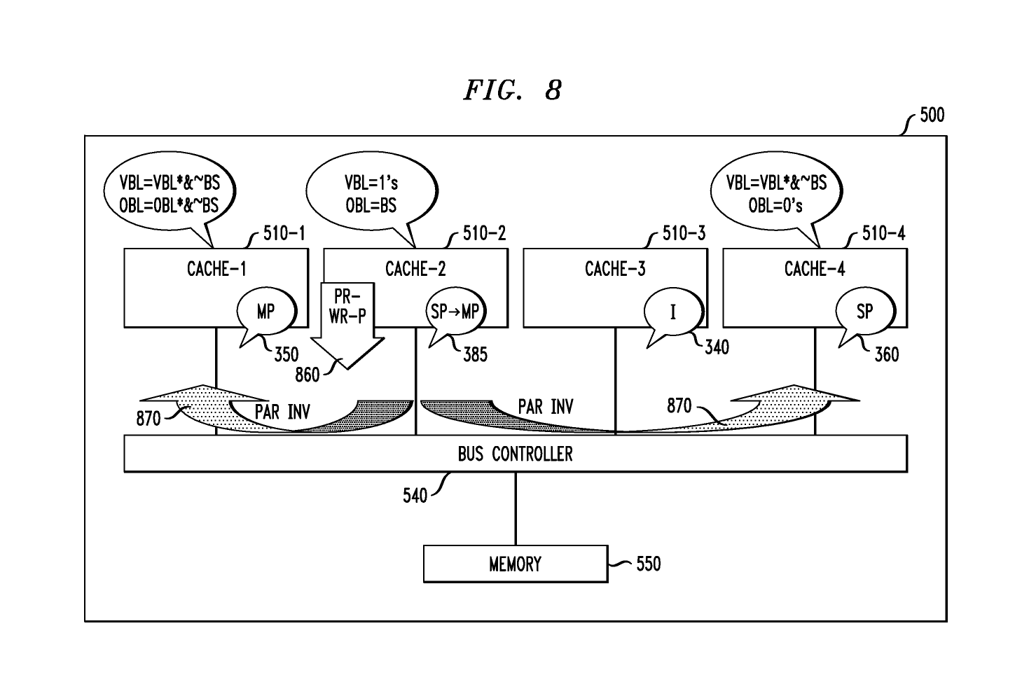

FIG. 8 illustrates the shared memory system 500 following a transition 385 in FIG. 3. In particular, transition 385 occurs for cache 510-2 after a processor associated with cache 510-2 issues a processor write-partial (PR-WR partial) operation 860, for a portion of a cache line (such as a byte) that is within the corresponding VBL and out of the corresponding OBL. In other words, at the time the write-partial (PR-WR partial) operation 860 is issued, cache 510-2 already has the valid data (VBL for the requested portion is equal to one) and just needs to obtain ownership of the modified portion (OBL for the requested portion is initially zero and needs to be changed to a value of one). Since cache 510-2 already has the valid data, a bus write partial transaction is not required.

As indicated in the Appendix for transition 385, if the modified byte lanes overlap with the existing VBL for the current PR-WR partial operation 860, a bus transaction ‘Partial Invalidate’ 870 is issued by the cache controller of cache 510-2 with the cache line address and with the byte strobe ‘BS’ to inform the peer caches to invalidate their ‘VBL/OBL’ corresponding to this BS based on this snoop request. Thus, as a result, cache 510-1 must give up validity and ownership of the modified portion and cache 510-4 must give up the validity of the modified portion, by setting VBL to the prior VBL value logically ANDed with the inverted value of the BS and by setting OBL to the prior OBL value logically ANDed with the inverted value of the BS.

If, however, the modified byte lane(s) do not overlap with the existing VBL, a bus write—partial operation is issued (not shown in FIG. 8) to obtain the latest copy of data (modified by other caches in MP state 350) and to perform the write operation. The cache controller associated with the cache 510-2 that issues the PR-WR partial operation 860 obtains the latest coherent data from the peer cache, sets its VBL to all ones and also obtains ownership of the modified portion (OBL for the requested portion is initially zero and needs to be changed to a value of one). This is done in order to ensure that caches do not have multiple very small discrete chunks of VBLs set to ‘1’ (i.e., to ensure validity (VBL=1) on multiple contiguous bytes rather than discrete smaller chunks of data). If there is subsequently a wider read to the same cache line, a bus read is not required. The peer caches owning/sourcing the cache line must give up validity and ownership of the modified portion.

The transition 385 (FIG. 3) shown for cache 510-2 in FIG. 8 from the shared partial state 360 to a modified partial state 350 is discussed further below in the Appendix.

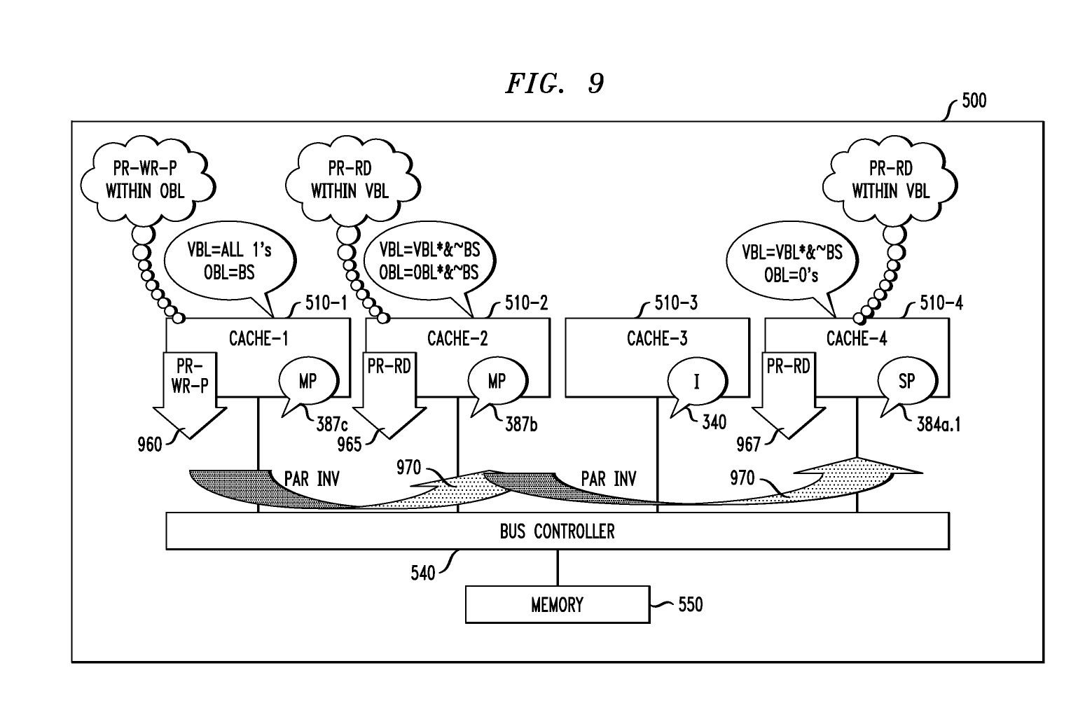

FIG. 9 illustrates the shared memory system 500 implementing multiple parallel processor transfers by the caches 510. As shown in FIG. 9, cache 510-1 is executing a processor write-partial (PR-WR-P) operation 960 to modify one or more bytes that it already owns (i.e., “within its OBL”). In addition, caches 510-2 and 510-4 are executing processor read operations 965, 967 on one or more bytes for which they already have valid data (i.e., “within its VBL”). Cache 510-1 follows transition 387c (MP state 350 to MP state 350), Cache 510-2 follows transition 387b (MP state 350 to MP state 350) and Cache 510-4 follows transition 384a.1 (SP state 360 to SP state 360 on a processor read operation 967), as discussed further below in the Appendix.

A bus transaction ‘Partial Invalidate’ 970 is issued by the cache controller of cache 510-1 with the cache line address and with the byte strobe ‘BS’ to inform the peer caches to invalidate their ‘VBL/OBL’ corresponding to this BS based on the snoop request due to processor write partial in cache 510-1. Thus, as a result, caches 510-2 and 510-4 must only give up validity and ownership of the modified portion. In this manner, the time consuming data phases can be avoided.

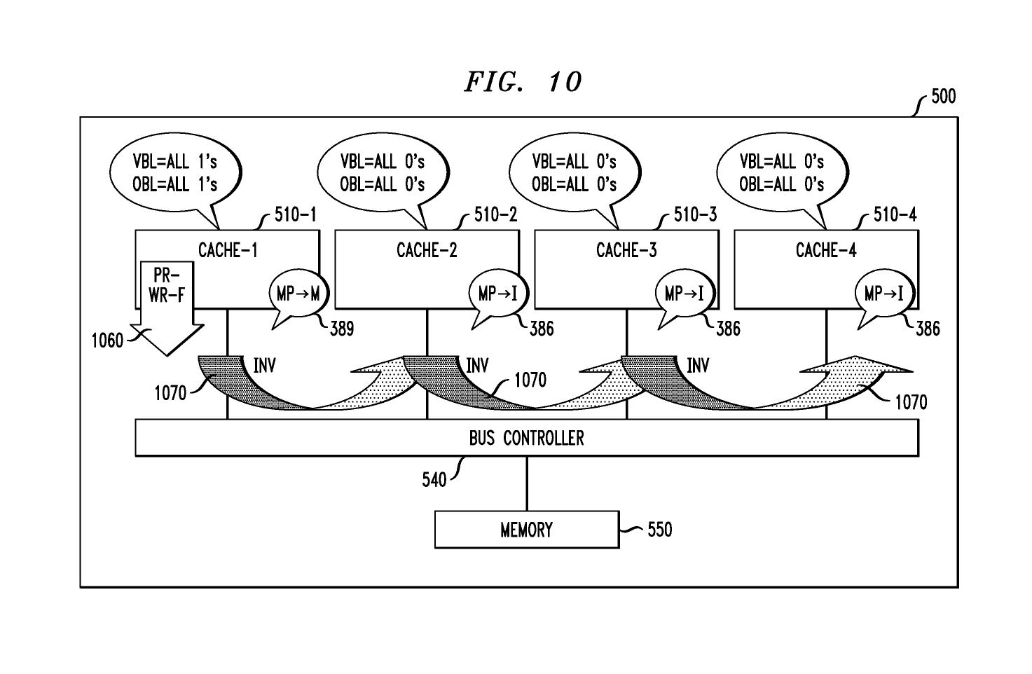

FIG. 10 illustrates the shared memory system 500 implementing a processor write-full operation (PR-WR-F) 1060 from cache 510-1, causing transition 389 from an MP state 350 to an M state 310. At the time of the operation, the VBL for the cache line in cache 510-1 is all ones. Thus, the processor need not issue a bus write command. Rather, the processor associated with cache 510-1 issues invalidate commands 1070 to inform the peer caches to invalidate this cache line, and to clear the values on their respective OBL and VBL fields (i.e., set OBL and VBL to all zeroes) using transition 386 from FIG. 3 and the Appendix.

Cache 510-1 follows transition 389 (MP state 350 to M state 310) and cache 510-2, 510-3 and 51-4 follow transition 386 (NIP state 350 to I state 340), as discussed further below in the Appendix.

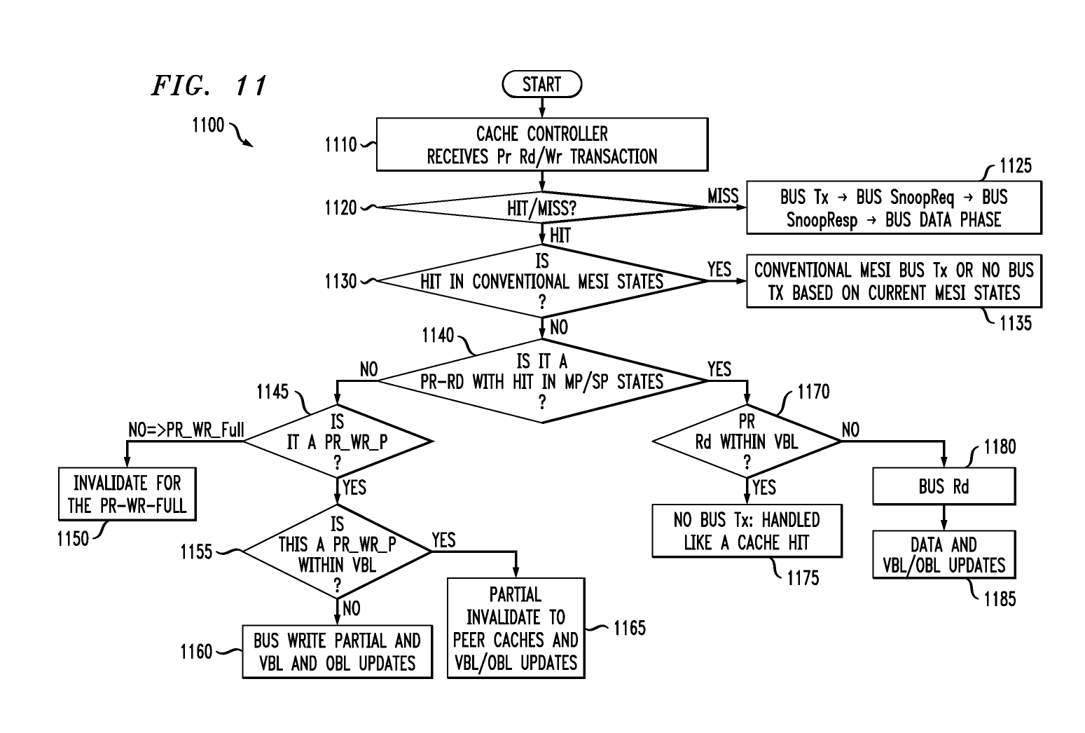

FIG. 11 is a flow chart describing a cache transaction handling process 1100 that may be implemented by a cache controller in accordance with an embodiment of the present invention. As shown in FIG. 11, the cache transaction handling process 1100 initially receives a processor read or write (Pr Rd/Wr) transaction during step 1110. A test is then performed during step 1120 to determine if the transaction results in a cache hit or a cache miss. If it is determined during step 1120 that there was a cache miss, then the process is handled in a conventional manner during step 1125 by issuing a bus transaction with a bus snoop request on the bus 130 and collecting the bus snoop responses for the bus data phase.

If, however, it is determined during step 1120 that there was a cache hit, then a further test is performed during step 1130, to determine if the cache hit is in a conventional MESI state. If it is determined during step 1130 that the cache hit is in a conventional MESI state, then a conventional MESI bus transaction is issued or no bus transaction is issued during step 1135, based on the current MESI state. and the incoming transaction.

If, however, it is determined during step 1130 that the cache hit is not in a conventional MESI state, then a further test is performed during step 1140 to determine if the transaction is a processor read operation (PR-RD) with a cache hit in an MP state 350 or an SP state 360. If it is determined during step 1140 that the transaction is not a processor read operation (PR-RD) (with a cache hit in an MP state 350 or an SP state 360), then a further test is performed during step 1145 to determine if the operation is a processor write partial operation (PR_WR_P) (or a processor write full operation (PR_WR_Full)).

If it is determined during step 1145 that the operation is not a processor write partial operation (i.e., the operation is a processor write full operation), then an invalidate operation is issued for the processor write full operation during step 1150.

If, however, it is determined during step 1145 that the operation is a processor write partial operation, then a further test is performed during step 1155, to determine if the processor write partial operation is within the VBL. If it is determined during step 1155 that the processor write partial operation is not within the VBL, then a bus write partial operation and updates to the VBL and OBL values are processed during step 1160. If, however, it is determined during step 1155 that the processor write partial operation is within the VBL, then a partial invalidate command is issued to the peer caches and the updates to the VBL/OBL values are processed during step 1165.

If, however, it is determined during step 1140 that the operation is a processor read operation (PR-RD) with a cache hit in an MP state 350 or an SP state 360, then a further test is performed during step 1170 to determine if the operation is a processor read operation within the VBL. If it is determined during step 1170 that the operation is a processor read operation within the VBL, then a bus transaction is not needed (the cache controller already has all necessary data), and the operation is handled in a similar manner to a cache hit during step 1175.

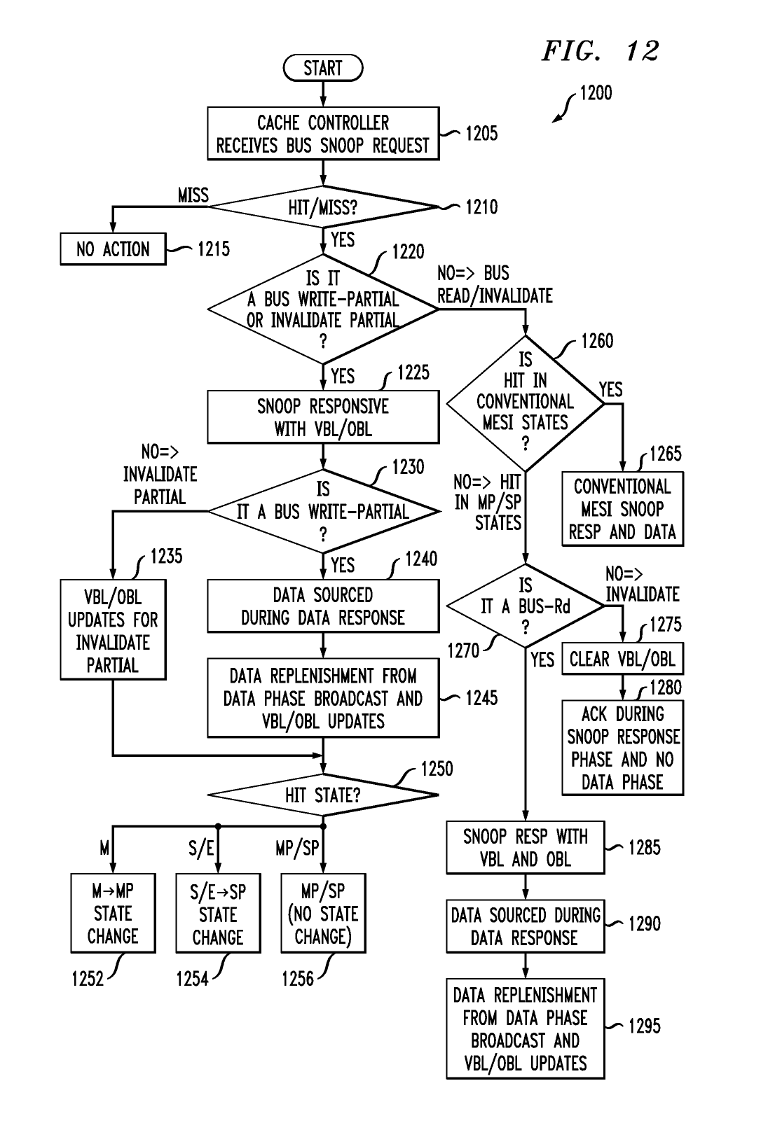

If, however, it is determined during step 1170 that the operation is not a processor read operation within the VBL, then a bus read operation is initiated during step 1180, as discussed further below in conjunction with FIG. 12. Finally, the data and updates to the VBI/OBL values are processed during step 1185.

FIG. 12 is a flow chart describing a bus transaction handling process 1200 that may be implemented by a cache controller to handle snoop requests in accordance with an embodiment of the invention. As shown in FIG. 12, the bus transaction handling process 1200 receives a bus snoop request during step 1205.

A test is performed during step 1210 to determine if there is a cache hit or a cache miss. If it is determined during step 1210 that there is a cache miss, then no action occurs during step 1215. If, however, it is determined during step 1210 that there is a cache hit, then a further test is performed during step 1220, to determine if the transaction is a bus write partial or an invalidate partial operation. If it is determined during step 1220 that the transaction is a bus write partial or an invalidate partial operation, then a snoop response is issued during step 1225 with the VBL/OBL values.

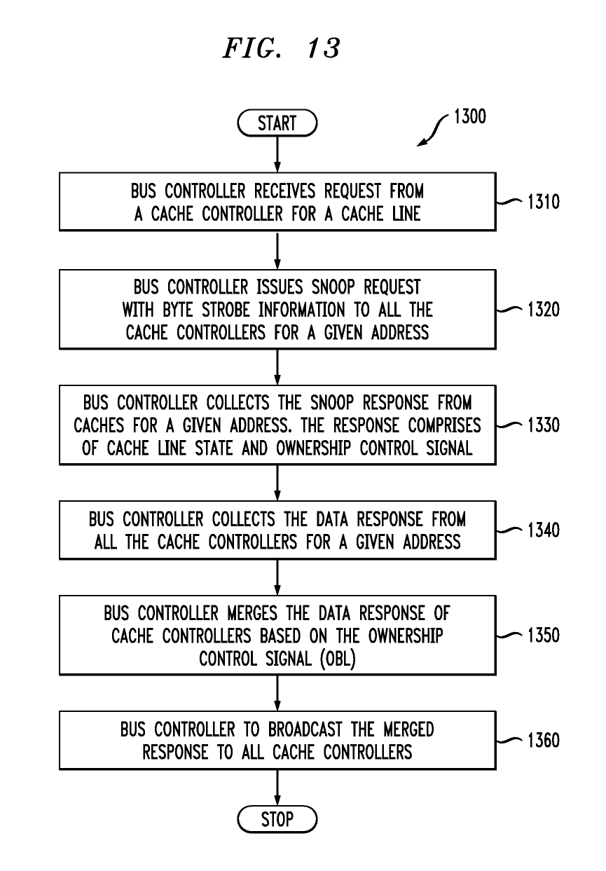

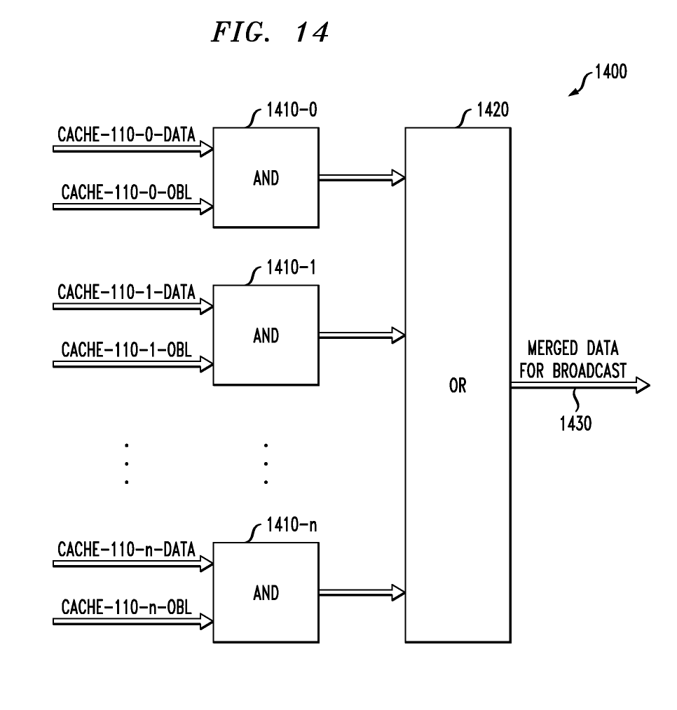

Thereafter, a further test is performed during step 1230 to determine if the transaction is a bus write partial operation. If it is determined during step 1230 that the transaction is not a bus write partial operation (i.e., the transaction is an invalidate partial operation), then the updates to the VBL/OBL values for the invalidate partial operation are processed during step 1235. If, however, it is determined during step 1230 that the transaction is a bus write partial operation, then the data is sourced during the data response phase during step 1240 and data replenishment is performed from the merged data broadcast by the bus controller (see FIGS. 13 and 14) and the updates to the VBL/OBL values are processed during step 1245.

A further test is performed during step 1250 to determine the current state. If it is determined during step 1250 that the current sate is a modified state 310, then there is a state change from a modified state 310 to a modified partial state 350 during step 1252. If it is determined during step 1250 that the current sate is a shared state 330 or an exclusive state 320, then there is a state change from a shared or exclusive state 330, 320 to a shared partial state 350 during step 1254. If it is determined during step 1250 that the current sate is a modified partial state 350 or a shared partial state 360, then there is no state change during step 1256.

If, however, it is determined during step 1220 that the transaction is not a bus write partial or an invalidate partial operation (i.e., the operation is a bus read or a full invalidate operation), then a further test is performed during step 1260 to determine if the cache is in a conventional MESI state. If it is determined during step 1260 that the cache is in a conventional MESI state, then conventional MESI snoop and data responses are processed during step 1265. If, however, it is determined during step 1260 that the cache is not in a conventional MESI state, then a further test is performed during step 1270 to determine if the operation is a bus read.

If it is determined during step 1270 that the operation is not a bus read (i.e., the operation is an invalidate command), then the VBL and OBL values are cleared (e.g., set to all zeroes) during step 1275 and an acknowledgement (ACK) is provided during the snoop response phase (step 1280) and a data phase is not needed.

If, however, it is determined during step 1270 that the operation is a bus read, then a snoop response is sent during step 1285 with the VBL and OBL values. The data is sourced during the data response (step 1290). Finally, the data is replenished from the merged data broadcast by the bus controller (see FIGS. 13 and 14) and the updates to the VBL/OBL values are processed during step 1295.

FIG. 13 is a flow chart describing a bus transaction handling process 1300 that may be implemented by a bus controller 140 in accordance with an embodiment of the invention. As shown in FIG. 13, the bus transaction handling process 1300 initially receives a request from a cache controller for a cache line during step 1310. Thereafter, the bus controller 140 issues a snoop request during step 1320 with byte strobe information to all the cache controllers for a given address.

The bus controller 140 then collects the snoop response from the caches for a given address. During step 1330. The collected responses comprise cache line states and ownership control signals. The data response are collected during step 1340 from all the cache controllers for a given address.

The bus controller 140 merges the data responses of the cache controllers during step 1350 based on the ownership control signals (OBLs). Thereafter, the bus controller 140 broadcasts the merged response to all cache controllers during step 1360.

FIG. 14 is a block diagram of a multiplexer 1400 that may be employed by the bus controller 140 to merge the collected data from the various caches 110 based on the OBL values during the data phase to form the merged data for broadcast. As shown in FIG. 14, the multiplexer 1400 comprises a plurality of AND gates 1410-0 through 1410-n and an OR gate 1420. The data from the data phase and the OBL value from the snoop response for each cache 110 (cache 110-0 through cache 110-n) are applied to a corresponding AND gate 1410. Thus, the output of each AND gate 1410 corresponds only to the data bits modified and hence owned by the corresponding cache. The output of each AND gate 1410 is applied to an OR gate 1420, which generates the merged data 1430 for broadcast to the peer caches 110.

As previously indicated, the bus controller and cache controller systems described herein provide a number of advantages relative to conventional arrangements. Again, it should be emphasized that the above-described embodiments of the invention are intended to be illustrative only. In general, the exemplary bus controller and cache controller systems can be modified, as would be apparent to a person of ordinary skill in the art, to incorporate the sharing of cache lines and the merging of shared cache data in accordance with the present invention. In addition, the disclosed cache line sharing techniques can be employed in any bus controller or buffered cache controller system, irrespective of the underlying cache coherency protocol. Among other benefits, the present invention offers significant reductions in bus traffic by avoiding snooping eviction transactions and subsequent cache line refills.

Cache misses in a cache controller could occur because the cache line was not referenced before (prior cache line fill has not happened) or the cache line was present and was evicted due to aging (e.g., a least recently used or snooping eviction). The present invention reduces the miss rate caused by the snooping eviction as only a Processor Write Full in a peer cache resulting in a Bus Invalidate operation causes a snooping eviction (basically an Invalidate operation due to Write Full Operation in the peer cache)

When a processor ‘P’ accesses a cache line that was already accessed before (e.g., 50% of the processor accesses are to already referenced cache lines) and the cache line is not evicted due to an aging eviction, the following scenarios hold:

1. A processor read operation will mostly result in a cache hit (no bus read is needed) if the cache line is frequently accessed across the peer caches. Hence, the cache line would have its VBL in each peer cache set to all ones due to the frequent replenishment of the data during the data response phases;

2. A processor write operation will result in cache hit if the partial write is to the portion of the cache line already owned by the cache (indicated by the OBL value) (one cycle to indicate to the peer caches to invalidate byte lanes that are about to be modified (Partial Invalidate));

3. A processor write operation will result in a cache hit if the partial write operation is within the portion of the cache line not already modified (i.e., owned) by the cache but contains the latest coherent data (not in OBL but present in VBL) (one cycle to indicate to the peer caches to invalidate byte lanes that are about to be modified (Partial Invalidate));

4. A processor write operation will result in a cache miss if the partial write operation is to the portion of the cache line not having the latest modified data of the cache line (not in VBL) (Bus Write Partial) or if it is a complete cache line write.

Assume that the probability of an aging eviction is P(ae); the probability of a read operation is P(r); the probability of a write operation is P(w); Bus transaction Latency is BL; and NUM_PROC is the number of Processors/Caches connected to the bus in a symmetric multi processor system.

Thus, the bus access time for an embodiment of the invention can be expressed as:

(Probability of access to previously unreferenced cache line−P(ur))*(Bus access latency for cache line; plus

(Probability of access to previously referenced cache lines−P(r))*(Probability of the location already evicted due to aging eviction)*(Bus access latency for cache line fill); plus

(Probability of access to previously referenced cache lines−P(r))*(Probability that the location is already not evicted due to only aging eviction and is in SP or MP states)*(P(r)*(0)+P(w)*(1)).

The probability that the cache line is already not evicted, due to only aging eviction and is in SP or MP states is (1−P(ae))*(2/6)=(1−P(ae))*0.33.

A cache line that is frequently accessed across the peer caches would have all its VBL for each peer cache set to one due to the frequent replenishment of the data during the data response phases. Hence, this cache line in an MP/SP state would have a hit on most of the processor read accesses. Hence, it is assumed that the Average Bus Latency for a processor read for a cache line in MP/SP state would be close to 0. Also, a processor write-partial would most likely initiate a Partial Invalidate on the bus. Hence, it is assumed that the Average Bus Latency for a processor write for a cache line in MP/SP state would be close to 1.

Thus, the bus access time for an embodiment of the invention can be expressed as:

[P(ur)*(BL)]+[(1−P(ur))*((P(ae)*(BL))+((1−P(ae)*0.33* (P(r)*(0)+P(w)*(1)))))]

Assuming that the average bus cycles required in a conventional MESI cache system is 8 clock cycles (miss resulting in cache line fills), then

P(w): Probability of partial writes is 0.5;

P(r): Probability of reads is 0.5; and

P(ur): Probability of unreferenced cache lines

P(ae): Probability of aging eviction

$$P ( se ) \text{:} Probability of snooping eviction = [ ( 0.5 ) * 8 + [ 0.5 * ( P ( ae ) * 8 ) + ( 1 - P ( ae ) ) * 0.33 * ( ( 0.5 * 0 ) + ( 0.5 ) * 1 ) ] = 4 + 4 * P ( ae ) + 0.166 ( 1 - P ( ae ) )$$

The bus access time for conventional ME I protocol can be expressed as:

(Probability of access to previously unreferenced cache line−P(ur))*(Bus access latency for cache line; plus

(Probability of access to previously referenced cache lines−P(r)*(Probability of the location already evicted due to aging eviction or snooping eviction)*(Bus access latency for cache line fill); plus

(Probability of access to previously referenced cache lines−P(r))*(Probability that the location is already not evicted due to aging eviction or snooping eviction; i.e a hit) *(P(r)*(0)+P(w)*(0)).

$$[ P ( ur ) * ( BL ) ] + [ ( 1 - P ( ur ) ) * ( ( ( P ( ae ) + P ( se ) ) * BL ) + ( 1 - P ( ae ) - P ( se ) ) * ( ( P ( R ) * 0 ) + P ( w ) * 0 ) ) = 4 + 4 * ( P ( ae ) + P ( se ) ) + ( 1 - P ( ae ) - P ( se ) * 0 = 4 + 4 * ( P ( ae ) + P ( se ) )$$

The reduction in bus transaction latency can be expressed as follows:

$$\% Reduction is bus transaction latency = 100 * ( Bus Access Time in Original MESI - Bus Access Time for present invention ) / ( Bus Access Time in original MESI ) . = 100 * [ ( 4 + 4 * ( P ( ae ) + P ( se ) ) ) - ( 4 + 4 * P ( ae ) + 0.166 ( 1 - P ( ae ) ) ) ] / ( 4 + 4 * ( P ( ae ) + P ( se ) ) ) = 100 * [ 4 * P ( se ) - ( 0.166 * ( 1 - P ( ae ) ) ) ] / ( 4 + 4 * ( P ( ae ) + P ( se ) ) )$$

While embodiments of the present invention have been described with respect to processing steps in a software program, as would be apparent to one skilled in the art, various functions may be implemented in the digital domain as processing steps in a software program, in hardware by a programmed general-purpose computer, circuit elements or state machines, or in combination of both software and hardware. Such software may be employed in, for example, a hardware device, such as a digital signal processor, application specific integrated circuit, micro-controller, or general-purpose computer. Such hardware and software may be embodied within circuits implemented within an integrated circuit.

In an integrated circuit embodiment of the invention, multiple integrated circuit dies are typically formed in a repeated pattern on a surface of a wafer. Each such die may include a device as described herein, and may include other structures or circuits. The dies are cut or diced from the wafer, then packaged as integrated circuits. One skilled in the art would know how to dice wafers and package dies to produce packaged integrated circuits. Integrated circuits so manufactured are considered part of this invention.

A typical integrated circuit design flow starts with an architectural design specification. All possible inputs are considered at this stage for achieving the required functionality. The next stage, referred to as Register Transfer Logic (RTL) coding, involves coding the behavior of the design (as decided in architecture) in a hardware description language, such as Verilog, or another industry-standard hardware description language. Once the RTL captures the expected design features, the RTL is applied as an input to one or more Electronic Design and Automation (EDA) tools.

The EDA tool(s) convert the RTL code into the logic gates and then eventually into a GDSII (Graphic Database System) stream format, which is an industry-standard database file format for data exchange of integrated circuit layout artwork. The GDSII stream format is a binary file format representing planar geometric shapes, text labels, and other information about the layout in hierarchical form, in a known manner. The GDSII file is processed by integrated circuit fabrication foundries to fabricate the integrated circuits. The final output of the design process is an integrated circuit that can be employed in real world applications to achieve the desired functionality.

Thus, the functions of embodiments of the present invention can be in the form of methods and apparatuses for practicing those methods. One or more embodiments of the present invention can be in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. Embodiments of the invention can also be implemented in one or more of an integrated circuit, a digital signal processor, a microprocessor, and a micro-controller.

It is to be understood that the embodiments and variations shown and described herein are merely illustrative of the principles of this invention and that various modifications may be implemented by those skilled in the art without departing from the scope and spirit of the invention.

Appendix

The following table specifies the exemplary transitions 371-396 between states 310, 320, 330, 340, 350, 360 and their respective description (where Arc No. in the following table indicates the transition number identified in FIG. 3).

| | | | | Notes on action of cache | |
|---|---|---|---|---|---|
| Arc | Current | Incoming | Next | handling | Notes on action of peer |
| No: | State | Transaction | State | the incoming transaction | caches |
| 373 | I | Processor | M | The cache updates its byte | VBL = all 0s and OBL = |
| | | Write to full | | strobe information (OBL) to all | all 0s |
| | | Cache line; | | 1s when a processor write | |
| | | or | | happens to a full cache line | |
| | | Processor | | (VBL = all 1s OBL = all 1s) | |
| | | partial write | | when the access is a processor | |
| | | with snoop | | write partial and the snoop | |
| | | response | | response received from Bus | |
| | | being Invalid. | | Controller is Invalid (VBL = all | |
| | | | | 1s OBL = all 1s). | |
| 374 | I | Processor | E | Processor Read main Memory | The peer caches set: |
| | | Read | | 150 sources the data for current | VBL = all 0s and OBL = |
| | | | | cache: VBL = all 1s OBL = all 1s | all 0s |
| 372 | I | Processor | S | Peer caches source the data for | Peer Caches that contain a |
| | | Read | | the bus read and the cache | copy of the data have: |
| | | | | reading the cache line has VBL = | VBL = all 1s, and OBL = |
| | | | | all 1s and OBL = all 1s | all 0s |
| 388 | I | Processor | SP | A bus read is issued to the | Peer caches which source |
| | | Read with | | Processor read resulting in a | the data for this cache line |
| | | Snoop | | Cache Miss. If the snoop | replenish their data |
| | | Response == | | response obtained for this bus | content. i.e VBL = all 1's. |
| | | MP Only or | | read is ‘MP’ the cache moves to | OBL contents in each of |
| | | MP + SP states | | SP state with the following | the caches remain |
| | | | | VBL/OBL updates: VBL = all | unchanged |
| | | | | 1's, OBL = all 0's | |
| 371 | I | Processor | MP | A bus write partial is issued. | Peer caches in ‘M’ state |
| | | Partial Write | | | move to ‘MP’ in response |
| | | with Snoop | | | to Bus Write Partial. |
| | | Response ! = I | | | Peer caches in ‘S’ state |
| | | | | | move to ‘SP’ state in |
| | | | | | response to Bus Write |
| | | | | | Partial. |
| | | | | | Peer caches in ‘MP’/‘SP’ |
| | | | | | state continue to stay in |
| | | | | | ‘MP/SP’ state respectively: |
| | | | | | VBL = VBL & ~BS, |
| | | | | | OBL = OBL & ~BS |
| 390 | E | Invalidate | I | Clears VBL and OBL and | Peer Cache requesting for |
| | | | | Invalidates the cache line | BW-Full |
| | | | | | VBL = all 1s |
| | | | | | OBL = all 1s |
| 391 | S | Invalidate | I | Clears VBL and OBL if they | Peer Cache requesting for |
| | | | | haven been set | BW-Full |
| | | | | and Invalidates the cache line | VBL = all 1s |
| | | | | | OBL = all 1s |
| 380 | M | Invalidate | I | Clears VBL and OBL and | Peer Cache requesting for |
| | | | | Invalidates the cache line | BW-Full |
| | | | | | VBL = all 1s |
| | | | | | OBL = all 1s |
| 386 | MP | Invalidate | I | Clears VBL and OBL and | Peer Cache requesting for |
| | | | | Invalidates the cache line | BW-Full |
| | | | | | VBL = all 1s |
| | | | | | OBL = all 1s |
| 382 | SP | Invalidate | I | Clears VBL and OBL and | Peer Cache requesting for |
| | | | | Invalidates the cache line | BW-Full |
| | | | | | VBL = all 1s |
| | | | | | OBL = all 1s |
| 377 | E | Processor | M | VBL = all 1s and OBL = all 1s | Peer caches respond by |
| | | Write to full | | | clearing their byte strobes |
| | | Cache line. | | | to ‘Invalidate’: VBL = all |
| | | Results in a | | | 0s and OBL = All 0s |
| | | ‘Invalidate’ | | | |
| | | bus | | | |
| | | transaction | | | |
| 376 | E | Bus Read | S | The current cache updates its | The peer cache that |
| | | | | byte strobe information to | initiates the Bus Read set: |
| | | | | VBL = all 1s and OBL = all 0's | VBL = all 1s and OBL = |
| | | | | | all 1s. |
| | | | | | The last cache which |
| | | | | | makes the Bus read has |
| | | | | | complete ownership of the |
| | | | | | cache line. |
| 375 | E | Bus Write | SP | Caches sources the data and | Peer Cache requesting for |
| | | Partial | | updates its own byte strobe | BW-paritial |
| | | | | information (VBL in its tag | VBL = all 1s |
| | | | | array) by clearing the lanes that | OBL = all 1s |
| | | | | are going to be written by this | |
| | | | | partial write and moves to ‘SP’ | |
| | | | | state. | |
| | | | | VBL = all 1s & ~BS. | |
| | | | | OBL = 0 | |
| 381 | M | Bus Read | S | Cache that is in ‘M’ state | Peer Cache requesting |
| | | | | sources the data and updates as | Bus Read updates as |
| | | | | follows: | follows: VBL = all 1s |
| | | | | VBL = all 1s OBL = all 0s | OBL = all 1s |
| 379 | M | Bus Write | MP | Cache that is in ‘M’ state sourced | Peer cache requesting for |
| | | Partial | | the data and updates VBL and | BW-Partial |
| | | | | OBL: | VBL = all 1's |
| | | | | VBL = VBL (earlier all 1's) & | OBL = BS |
| | | | | ~BS; OBL = OBL (earlier all | |
| | | | | 1's) & ~BS | |
| 389 | MP | Processor | M | Invalidate is issued on the bus | Peer caches in ‘MP/SP’ |
| | | Write to | | and the cache performs the | states invalidate the cache |
| | | full Cache | | complete cache line write and | line. |
| | | line | | updates the VBL/OBL as: | Optinally could clear |
| | | | | VBL = all 1's, OBL = all 1's | VBL and OBL. |
| 392 | S | Processor | M | Invalidate is issued on the bus | Peer caches in ‘S” state |
| | | Write Full | | and the cache performs the | invalidate the cache line. |
| | | | | complete cache line write and | Optionally could clear |
| | | | | updates the VBL/OBL as: | VBL and OBL |
| | | | | VBL = all 1's, OBL = all 1's | |
| 383 | SP | Processor | M | Invalidate is issued on the bus | Peer caches in ‘MP/SP’ |
| | | Write to full | | and the cache performs the | states invalidate the cache |
| | | cache line | | complete cache line write and | line. |
| | | | | updates the VBL/OBL as: VBL = | Optinally could clear |
| | | | | all 1s OBL = all 1s | VBL and OBL. |
| 393 | S | Processor | MP | Invalidate Partial is issued on the | Peer caches in ‘S’ state |
| | | Write Partial | | bus and the cache performs the | move to ‘SP’ state due to |
| | | | | partial write and updates the | the partial invalidate on |
| | | | | VBL/OBL as: VBL = all 1's, | the bus and update |
| | | | | OBL = all 1's | VBL/OBL as: VBL = VBL |
| | | | | | (all 1's) & ~BS, OBL = all |
| | | | | | 0's |
| 378 | S | Bus Write | SP | The current cache sources the | Peer cache requesting |
| | | Partial | | data with the byte strobe | BW-Partial: |
| | | | | information (VBL) and updates | VBL = all 1s |
| | | | | its own byte strobe information | OBL = all 1s |
| | | | | (VBL in its tag array) by | |
| | | | | clearing the lanes that are going | |
| | | | | to be written by this partial write | |
| | | | | and moves to ‘SP’ state | |
| | | | | VBL = all 1s & ~BS OBL = all 0s | |
| 385 | SP | Processor | MP | Case (1) If byte lanes for the | Case (1) If byte lanes for |
| | | partial write | | Processor Write Partial overlap | the Processor Write |
| | | | | with the existing VBL | Partial overlap with the |
| | | | | A bus transaction called ‘Partial | existing VBL |
| | | | | Invalidate’ is issued only with | Peer Caches that have this |
| | | | | the cache line address and ‘BS’ | cache line: |
| | | | | to inform the peer cache's to | VBL = VBL & ~ BS and |
| | | | | invalidate their ‘VBL/OBL’ | OBL = OBL & ~BS |
| | | | | based on this snoop request. | Case (2) If byte lanes for |
| | | | | VBL = VBL and OBL = OBL\| | the Processor Write |
| | | | | BS | Partial do not overlap with |
| | | | | Case (2) If byte lanes for the | the existing VBL |
| | | | | Processor Write Partial do not | Peer Caches |
| | | | | overlap with the existing VBL | owning/sourcing the |
| | | | | A bus write—partial is issued to | cache line: |
| | | | | obtain the latest copy of data | VBL = VBL & ~ BS and |
| | | | | (owned by other caches in MP | OBL = OBL & ~BS |
| | | | | state) and perform the write. | |
| | | | | VBL = all 1s and OBL = OBL\| | |
| | | | | BS | |
| 384(a) | SP | Processor | SP | Case (1) If byte lanes overlap | Case (1) If byte lanes |
| | | Read | | with the existing VBL, no bus | overlap with the existing |
| | | | | transaction is issued and the read | VBL, No action as there is |
| | | | | data is sourced from the cache. | no Bus transaction |
| | | | | Case (2) If byte lanes do not | Case (2) If byte lanes do |
| | | | | overlap with the existing VBL, a | not overlap with the |
| | | | | Bus Read (for Processor Read) | existing VBL, Peer |
| | | | | is issued to obtain the latest copy | Caches sourcing data |
| | | | | of data (owned by other caches | updates as follows: VBL = |
| | | | | in MP state); set | all 1s and OBL = OBL |
| | | | | VBL = all 1s and OBL = 0s | |
| 384(b) | SP | Bus Write | SP | When a Bus Write Partial for the | Peer Cache requesting |
| | | partial | | cache line is issued to the cache: | BW partial updates as |
| | | | | During data phase for this Bus | follows: VBL = all 1s and |
| | | | | write partial, the following | OBL = BS |
| | | | | updates happen: VBL = VBL & | |
| | | | | ~BS and OBL = OBL & ~BS | |
| 387(a) | MP | Bus Write | MP | Cache sources the data and | The peer cache issuing the |
| | | partial | | updates its own byte strobe | Bus write partial cache |
| | | | | information (in its tag array) by | line: |
| | | | | clearing the lanes that are going | VBL = All 1s and OBL = |
| | | | | to be written by the snooper/peer | OBL\|BS |
| | | | | cache. | |
| | | | | VBL = VBL & ~ BS and OBL = | |
| | | | | OBL & ~BS | |
| 387(b) | MP | Processor | MP | Case (1) If the byte lanes | Case (1) If byte lanes |
| | | Read | | overlap with the existing VBL, | overlap with the existing |
| | | | | no bus transaction is issued and | VBL. No action as there is |
| | | | | the read data is sourced from the | no Bus transaction |
| | | | | cache. | Case(2) If byte lanes do |
| | | | | Case (2) If byte lanes do not | not overlap with the |
| | | | | overlap with the existing VBL, a | existing VBL, the peer |
| | | | | bus read is issued to obtain the | Caches that have the |
| | | | | latest copy of data (owned by | cache line replenish the |
| | | | | other caches in MP state) and | data during data phase |
| | | | | source the read data back. | broadcase and update |
| | | | | VBL = All 1s and OBL = OBL | VBL/OBL as follows: |
| | | | | (No Change) | VBL = All 1s and OBL = |
| | | | | | OBL (No Change) |
| 387(c) | MP | Process Write | MP | Case (1) If byte lanes overlap | Case (1) If byte lanes |
| | | Partial | | with the existing OBL, a bus | overlap with the existing |
| | | | | transaction is issued only with | OBL, The peer caches |
| | | | | the cache line address and ‘BS’ | that have the cache line |
| | | | | to inform the peer caches to | during the Partial |
| | | | | invalidate their ‘VBL’ based on | Invalidate bus transaction |
| | | | | this snoop request. VBL = VBL | make VBL/OBL updates |
| | | | | and OBL = OBL | as follows: VBL = VBL |
| | | | | Case (2) If byte lanes do not | & ~BS and OBL = OBL & |
| | | | | overlap with the existing OBL | ~BS |
| | | | | but overlap with ‘VBL’, a bus | Case (2) If byte lanes do |
| | | | | transaction is issued only with | not overlap with the |
| | | | | the cache line address and ‘BS’ | existing OBL but overlap |
| | | | | to inform the peer caches to | with ‘VBL’, the peer |
| | | | | invalidate their VBL and OBL | caches that have the cache |
| | | | | based on this snoop request | line during the Partial |
| | | | | (issue ‘paritial_invalidate’ on the | Invalidate bus transaction |
| | | | | bus): VBL = VBL and OBL = | make VBL/OBL updates |
| | | | | OBL\|BS | as follows: VBL = VBL |
| | | | | Case (3) If byte lanes do not | & ~BS and OBL = OBL & |
| | | | | overlap with the existing OBL | ~BS |
| | | | | and VBL, a bus write partial | Case (3) If byte lanes do |
| | | | | needs to be issued to obtain the | not overlap with the |
| | | | | latest copy of data (owned by | existing OBL and VBL, |
| | | | | other caches in MP state) and | the peer caches that have |
| | | | | perform the write. | the cache line during the |
| | | | | VBL = VBL\|BS and OBL = | Bus Write Partial perform |
| | | | | OBL\|BS. | the following VBL/OBL |
| | | | | | Updates after sourcing |
| | | | | | their data: VBL = VBL & |
| | | | | | ~BS and OBL = OBL & |
| | | | | | ~BS |
| 394 | M | Processor | M | No change in VBL/OBL | |
| | | Write/ | | | |
| | | Processor | | | |
| | | Read | | | |
| 395 | E | Processor | E | No change in VBL/OBL | |
| | | Read | | | |
| 396 | S | Processor | S | No change in VBL/OBL | |
| | | Read | | | |

We claim:

1. A cache, comprising:
a plurality of cache lines; and
a cache controller for sharing at least one of said cache lines with one or more additional caches, wherein a given cache line shared by a plurality of caches corresponds to a given set of physical addresses in a main memory.

2. The cache of claim 1, wherein said cache controller maintains an ownership control signal indicating which portions of said at least one cache line are modified and controlled by said cache and the ownership control signal comprises a bit corresponding to each byte of said at least one cache line.

3. The cache of claim 1, wherein said cache controller maintains a validity control signal indicating whether each portion of said at least one cache line is valid and wherein said validity control signal comprises a bit corresponding to each byte of said at least one cache line.

4. The cache of claim 3, wherein each of said portions of said at least one cache line is valid if said portion contains the latest coherent data.

5. The cache of claim 1, wherein each of said cache lines can be in one of a plurality of cache coherence states.

6. The cache of claim 5, wherein said plurality of cache coherence states comprise a modified partial state and a shared partial state that allows said sharing of said cache lines.

7. The cache of claim 6, wherein said shared partial state allows a latest copy of a given cache line to be retained on selective portions of said given cache line.

8. The cache of claim 6, wherein said shared partial state allows coherent valid data to be obtained on a complete cache line with a plurality of peer caches retaining ownership on selective portions of said complete cache line.

9. The cache of claim 6, wherein said shared partial state allows coherent valid data to be obtained on a complete cache line and coherent valid data to be maintained on one or more of partial and complete cache lines with a plurality of peer caches retaining ownership on selective portions of said complete cache line.

10. The cache of claim 9, wherein a subsequent read operation of said cache line that overlaps with said portion results in a cache-hit in said shared partial state.

11. The cache of claim 6, wherein said modified partial state allows selective modification and ownership of parts of at least one cache line.

12. The cache of claim 6, wherein said modified partial state allows coherent valid data to be obtained on a complete cache line with a plurality of peer caches relinquishing ownership on the selective portions of said cache line that is to be modified.

13. The cache of claim 6, wherein said modified partial state allows coherent valid data to be maintained in a complete cache line with a plurality of peer caches retaining ownership on mutually exclusive selective portions of said complete cache line.

14. The cache of claim 13, wherein a subsequent read operation of said cache line that overlaps with said portion results in a cache-hit in modified partial state.

15. The cache of claim 13, wherein a subsequent partial write operation of said cache line that overlaps with said portion indicated by one or more of an ownership control signal and a validity control signal results in a cache-hit in modified partial state.

16. The cache of claim 13, wherein a subsequent partial write operation of said cache line that overlaps with said portion indicated by one or more of an ownership control signal and a validity control signal results in a partial invalidate operation on a bus with byte strobes indicating portions that are to be modified by the partial write operation.

17. The cache of claim 1, wherein one or more of an ownership control signal and a validity control signal corresponding to said cache line is updated when there is one or more of a partial invalidate command and a bus write partial command on a bus based on a byte strobe signal in a snoop request.

18. The cache of claim 1, wherein data of said cache line is replenished and a validity control signal is set based on a broadcast of merged data on a bus corresponding to said cache line.

19. The cache of claim 1, wherein at least one of said cache lines can be shared with one or more additional caches using a plurality of cache coherence states with a plurality of peer caches retaining valid data on at least portions of said at least one cache line using a validity control signal and wherein said plurality of peer caches maintain partial ownership of at least portions of said at least one cache line using an ownership control signal, wherein said plurality of cache coherence states comprise a modified partial state and a shared partial state.

20. The cache of claim 1, wherein a modified cache line is not evicted for a snoop request of a partial write operation in peer caches by using one or more of an ownership control signal and a validity control signal and wherein said modified cache line transitions to a plurality of cache coherence states comprising a modified partial state and a shared partial state.

21. An integrated circuit, comprising:
cache controller circuitry operative to:
share at least one cache line in a first cache with one or more additional caches, wherein a given cache line shared by a plurality of caches corresponds to a given set of physical addresses in a main memory.

22. The integrated circuit of claim 21, wherein said cache controller maintains an ownership control signal indicating which portions of said at least one cache line are controlled by said cache.

23. The integrated circuit of claim 22, wherein said ownership control signal comprises a bit corresponding to each byte of said at least one cache line.

24. The integrated circuit of claim 21, wherein said cache controller maintains a validity control signal indicating whether each portion of said at least one cache line is valid.

25. The integrated circuit of claim 24, wherein said validity control signal comprises a bit corresponding to each byte of said at least one cache line.

26. The integrated circuit of claim 24, wherein each of said portions of said at least one cache line is valid if said portion contains the latest coherent data.

27. The integrated circuit of claim 21, wherein each of said cache lines can be in one of a plurality of cache coherence states.

28. The integrated circuit of claim 27, wherein said plurality of cache coherence states comprise a modified partial state and a shared partial state that allows said sharing of said cache lines.

29. The integrated circuit of claim 28, wherein said shared partial state allows a latest copy of a given cache line to be retained on selective portions of said given cache line.

30. The integrated circuit of claim 29, wherein said shared partial state allows coherent valid data to be obtained on a complete cache line with a plurality of peer caches retaining ownership on selective portions of said complete cache line.

31. The integrated circuit of claim 29, wherein said shared partial state allows coherent valid data to be obtained on a complete cache line and coherent valid data to be maintained on one or more of partial and complete cache lines with a plurality of peer caches retaining ownership on selective portions of said complete cache line.

32. The integrated circuit of claim 29, wherein a subsequent read of said cache line that overlaps with said portion results in a cache-hit.

33. A cache controller, comprising:
a memory; and
at least one hardware device, coupled to the memory, operative to:
share at least one cache line in a first cache with one or more additional caches, wherein a given cache line shared by a plurality of caches corresponds to a given set of physical addresses in a main memory.

34. The cache controller of claim 33, wherein said cache controller maintains an ownership control signal indicating which portions of said at least one cache line are controlled by said cache.

35. The cache controller of claim 34, wherein said ownership control signal comprises a bit corresponding to each byte of said at least one cache line.

36. The cache controller of claim 33, wherein said cache controller maintains a validity control signal indicating whether each portion of said at least one cache line is valid.

37. The cache controller of claim 36, wherein said validity control signal comprises a bit corresponding to each byte of said at least one cache line.

38. The cache controller of claim 36, wherein each portion of said at least one cache line is valid if said portion contains the latest coherent data.

39. The cache controller of claim 33, wherein each of said cache lines can be in one of a plurality of cache coherence states.

40. The cache controller of claim 39, wherein said plurality of cache coherence states comprise one or more of a modified partial state and a shared partial state that allows said sharing of said cache lines.

41. The cache controller of claim 40, wherein said shared partial state allows a latest copy of a given cache line to be retained on selective portions of said given cache line.

42. The cache controller of claim 40, wherein said shared partial state allows coherent valid data to be obtained on a complete cache line with a plurality of peer caches retaining ownership on selective portions of said complete cache line.

43. The cache controller of claim 40, wherein said shared partial state allows coherent valid data to be obtained on a complete cache line and coherent valid data to be maintained on one or more of a partial cache line and a complete cache line with a plurality of peer caches retaining ownership on selective portions of said complete cache line.

44. The cache controller of claim 41, wherein a subsequent read of said cache line that overlaps with said portion results in a cache-hit.

45. A cache control method, comprising:
controlling a plurality of cache lines; and
sharing at least one cache line in a first cache with one or more additional caches, wherein a given cache line shared by a plurality of caches corresponds to a given set of physical addresses in a main memory.

46. The method of claim 45, further comprising the step of maintaining an ownership control signal indicating which portions of said at least one cache line are controlled by said cache.

47. The method of claim 45, further comprising the step of maintaining a validity control signal indicating whether each portion of said at least one cache line is valid.

48. The method of claim 45, wherein each of said cache lines can be in one of a plurality of cache coherence states, wherein said plurality of cache coherence states comprise a modified partial state and a shared partial state that allows said sharing of said cache lines.
